(19) United States
(12) Patent Application Publication
(10) Pub. No.: US 2004/0099829 A1
(43) Pub. Date: May 27, 2004

(54) Mounting assembly for container valve shut-off device

(76) Inventor: Haji Hazni Bin Hashim, Lahat (MY)

Correspondence Address: JOEL D. SKINNER, JR., SKINNER AND ASSOCIATES, 212 COMMERCIAL ST., HUDSON, WI, 54016, US

(21) Appl. No.: 10/392,139

(22) Filed: Mar. 19, 2003

(30) Foreign Application Priority Data
Nov. 27, 2002 (MY) PI 20024433

(51) Int. Cl. F16K 35/00

(52) U.S. Cl. 251/89

(57) ABSTRACT

A mounting assembly for a container valve shut-off device such as a pneumatic ratchet consists of a holder for the ratchet, an articulation for controllably moving the ratchet holder so as to bring the ratchet into operational engagement with an exit valve on the container, and a stand for mounting the assembly on a support surface other than the container and valve. The assembly allows easy installation as well as temporary removal for maintenance and replacement work.

### CROSS-REFERENCE TO RELATED APPLICATIONS, IF ANY

Not applicable.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND

1. Field

This invention relates generally to safety systems for plant that require the supply of hazardous or toxic fluid from storage containers. More specifically, the invention is concerned with a mounting assembly for mounting a valve shut-off device in operational engagement with a fluid exit valve located on such a container.

2. Background Information

Shut-off systems are known which provide automatic rapid closure of chlorine container valves for the protection of personnel and property in the event that a leak is detected. Such safety systems may be triggered automatically by, for example, a gas detector, fire alarm or seismic detector, or manually by, for example, actuation of a panic button. One system of this kind uses pneumatic ratchets for valve shut-off, which are operated using bottled nitrogen. This allows totally pneumatic operation in the chlorine environment in conjunction with a remotely located electronic control panel that regulates the nitrogen supply to control the operation of the ratchets. The valves are closed automatically using this system, but must be manually re-opened after the alarm event is over.

### BRIEF SUMMARY OF INVENTION

In the above-described system, the pneumatic ratchet is mounted directly on the container using a special bracket. For a chlorine cylinder, the bracket is mounted on the base of the valve. For a drum container, such as a ton container, on the other hand, the known bracket is designed only for mounting directly on the inner chime of specific diameter range that is found on US standard ton containers. The known bracket is also intended only for use with valves of straight angle type. This bracket consists of two interconnected legs that provide three contact points between the bracket and the drum. Since most ton containers vary in shape and size, mounting the bracket requires the adjustment of holding bolts at two points, before securing a clamp at a third point. Thereafter, the or each ratchet is installed on the bracket and its output socket engaged with the valve stem.

Apart from the evidently complicated and time-consuming process of assembling and removing such brackets, non-US standard ton containers do not have the inner chime on which the design and operation of this bracket depends. The existing mounting bracket is therefore inconvenient to use and, moreover, is not suitable for use with other types of ton container and valves other than the straight angle type.

MY-109356-A discloses a valve operating mechanism for use in a safety system of the above general kind. Closure of the valves in this system is controlled using a fluid powered motor. The motor is mounted remote from the container. A shaft assembly connects the motor output shaft to a connector that engages the valve hand wheel. This system has considerable mechanical complexity, which is undesirable in terms of reliability and maintenance requirements.

There is thus a real need for an improved mounting assembly for a container valve safety shut-off system. In particular, what is needed is an assembly that can be quickly and readily installed (as well as removed, when necessary) and is capable of being used with containers of a variety of sizes and standards. The present invention aims to meet this need.

In accordance with a first aspect of the invention a mounting assembly for positioning a valve actuator in operational engagement with an exit valve located on a fluid storage container, comprises a valve actuator holder, means for controllably moving the holder so as to position such a valve actuator, held by the holder, in operational engagement with the valve, and support means for securing the assembly to a support surface other than the container or valve.

Preferably, the support surface is the floor or similar platform on which the container is also mounted.

The mounting assembly of the invention thus provides a convenient and effective means for locating the valve actuator in engagement of the valve, irrespective of the size or configuration of the container in the vicinity of the valve.

The means for controllably moving the valve actuator holder may comprise an arm that carries the valve actuator holder, the arm arranged for moving the valve actuator holder independently in different directions.

The arm may be extendible axially and may be adjustable in its height relative to the support surface.

In one embodiment, the means for controllably moving the valve actuator holder further comprises a bracket that couples the arm to the support means.

In this case, the bracket is preferably controllably movable and securable relative to the support means to perform the height adjustment.

Preferably, the arm is pivotally coupled to the bracket whereby the valve actuator holder can be swung vertically into proximity of the valve or out of proximity therefrom.

The bracket and arm may interact to limit the lower extent of swing of the arm to a generally horizontal disposition, and/or may interact to limit the upper extent of swing of the arm to a rearward disposition at an acute angle with the bracket.

Preferably, the bracket is pivotally connected to the support means to allow the arm to be swung horizontally.

The support means preferably includes a base plate adapted for being secured to the support surface.

All of the above features serve to facilitate accurate and user-friendly location and maintenance of the valve actuator at, and temporary removal of it from, its operative position relative to the exit valve.

The valve actuator is suitably a pneumatic ratchet, which may operate using nitrogen gas. The assembly and ratchet mounted thereon can then be used in a system of the general type first-mentioned in the introduction of this specification.

In accordance with a second aspect of the invention, therefore, a safety system for automatically shutting an exit valve of a fluid storage container, includes a pneumatic ratchet in operational engagement with the valve, and a mounting assembly according to the first aspect of the invention that supports the ratchet, wherein the mounting assembly is secured exclusively to a support surface other than the container or valve.

The pneumatic ratchet may be coupled directly to the valve stem via a socket at the ratchet output (typically of hexagonal section) that receives the valve stem. Alternatively, the exit valve may carry a hand wheel. In this case, the ratchet is coupled through an adapter having a pair of prongs that engage the hand wheel at one end, and a stem that engages the ratchet output socket at the other end. The prongs of the adapter are located in the gaps defined by the radial spokes and circumferential ring of the hand wheel.

The provision of this adapter increases the versatility of the system and ease of engagement between the actuator and valve, by allowing a valve with a hand wheel to be readily accommodated.

### BRIEF DESCRIPTION OF THE SEVERAL VIEWS OF THE DRAWING

The invention is illustrated, although not limited, by the following description of a preferred embodiment, given by way of example only, with reference to the accompanying drawings, in which:

FIG. 1 is a perspective view of the mounting assembly of the embodiment;

FIG. 2 is a side view of the mounting assembly of the embodiment;

FIG. 3 is a top view of the mounting assembly of the embodiment;

FIG. 4 is a side view of the mounting assembly in use, holding a safety ratchet in engagement with an exit valve of a ton container;

FIGS. 5(a)-(d) are perspective, plan, side and end views, respectively, of an adapter for use in coupling the ratchet to a valve hand wheel; and

FIGS. 6(a) and (b) are side and end views of the adapter in use.

### DETAILED DESCRIPTION

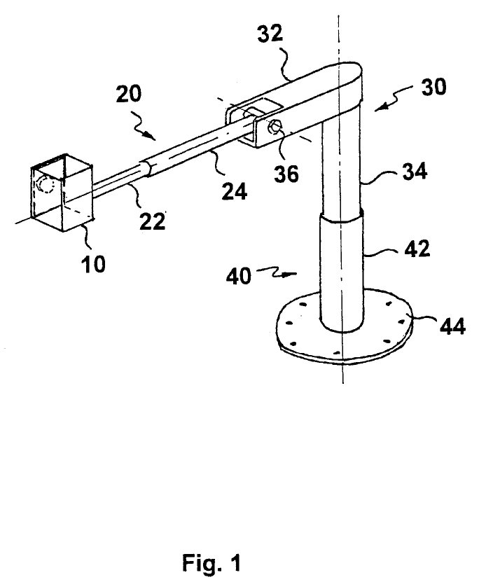

Referring firstly to FIGS. 1 to 3, a mounting assembly consists basically of three components: a support stand, an articulation, and a valve actuator holder. The holder 10 is designed for holding an actuator such as a pneumatic ratchet. It consists of a hollow rectangular box or section of metal, suitably stainless steel. The section 10 is open at both ends and has a length shorter than the ratchet to be held and its cross-section is oversized relative to the ratchet. It is internally lined with rubber pad. A pressure plate 14 is disposed internally adjacent one side of the metal section and linked to a hand screw 12. In use, the ratchet is slid into the box and its position adjusted axially relative to the section 10. To secure the ratchet in position, pressure is applied by moving the pressure plate 14 simply by tightening the hand screw 12.

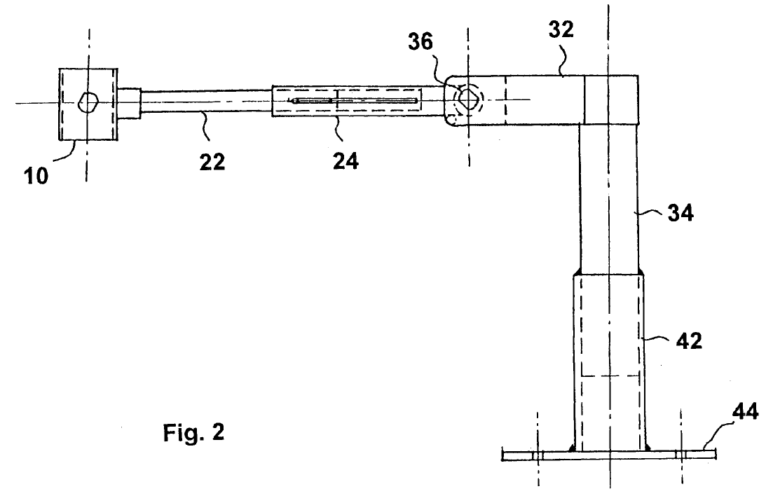

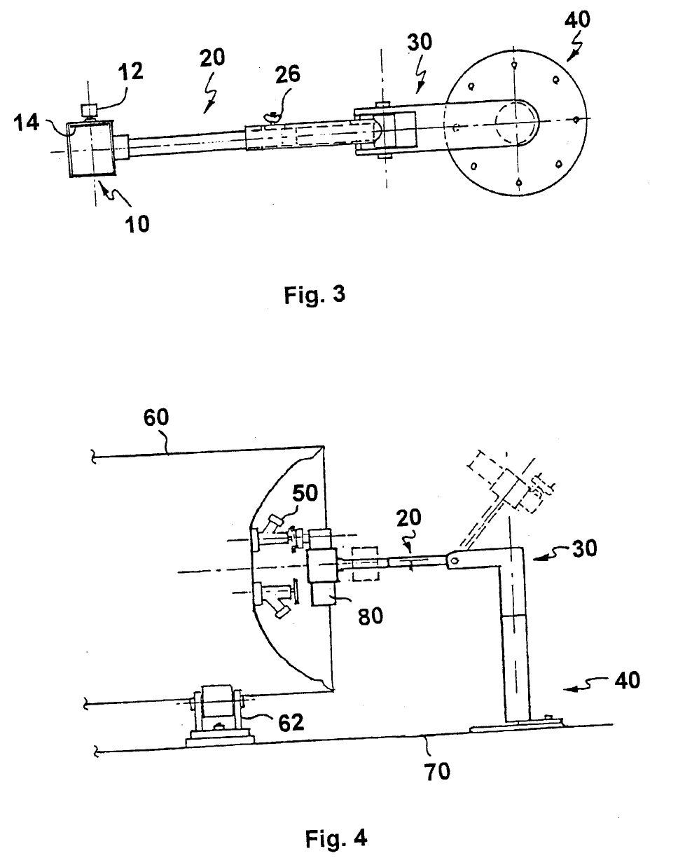

The articulation comprises an arm 20 and swivel bracket 30. The arm 20 consists of a shaft 22 that is slidable relative to a hollow tube 24. The shaft 22 is of solid section and has a diameter somewhat smaller than the inner diameter of the tube 24. As best seen in FIGS. 2 and 3, the shaft 22 carries a lug that rides in an axial slot formed in the tube 24 so as to limit the extension and retraction of the arm. The arm components are suitably constructed from stainless steel. In this embodiment, there is a respective lug and slot formed on horizontally opposite sides of the arm, although a single lug and slot may alternatively be sufficient. The distal end of the shaft 22 is rigidly secured to the ratchet holder 10. The inner, rear end of the arm 20 is coupled to the swivel bracket 30 by a pivot connection 36. This pivot connection 36 allows the arm to be lowered down into position in use, and swung upwardly and back when access to the container or valve is required. The bracket 30 consists of a horizontally extending leg 32 of hollow rectangular section, and adjoined thereto at 90°, a vertical leg 34 of circular section.

The support stand 40 consists of a vertical stem 42 of hollow, cylindrical form, and a base plate 44 rigidly secured to the lower end of the stem 42. The base plate 44 is suitably apertured to permit fastening of the stand to the floor or other support platform. The bracket 30 is preferably vertically adjustable and horizontally swingable relative to the stand 40, by virtue of the leg 34 of the bracket being movably located within the hollow stem 42. The vertical height of the arm may be adjustable by means of a monkey screw (not shown) that is used to secure the leg 34 to the stem 42.

As best seen in FIGS. 2 and 3, a stopper at the lower distal end of tube 32 serves to limit the downward motion of the arm 20 about the pivot 36. This stopper limits the arm to a generally horizontal disposition in which it is co-axial with the leg 32. The upward swivel of the arm 20 about pivot 36 is also limited by the edge of a cut-out in the upper wall of leg 32. This edge arrests the backward movement of the arm so as to allow the retracted arm to incline rearwardly at an acute angle relative to the leg 32, as seen in FIG. 4.

FIG. 4 shows the mounting assembly in use. After adjustment (if any) of the vertical height of the swivel bracket 30 relative to the stand, the arm is swung downwardly from the position shown in dotted lines to that shown in solid lines. The downward travel of the arm is arrested by the stopper mentioned above so the arm extends horizontally. The ratchet 80 secured in the holder 10 may then be moved forwardly into engagement with the exit valve 50 on a drum container 60, by adjustment of the extension of the arm 20. Once the actuator has been brought into the required position, the extension of the arm is fixed using the monkey screw 26. In this embodiment, the container 60 is mounted by supports 62 on the same surface 70 to which the stand 40 is secured. As will be seen from FIG. 4, the actuator 80 may be readily retracted using the arm 20 and then swung upwardly and away from the container to allow sufficient space and clearance for work such as replacing the container 60 when empty. Once the new container is positioned and the flexible tube fitted to the valve, the ratchet 80 may be brought back down to its horizontal position and slid forwardly to engage the valve 50.

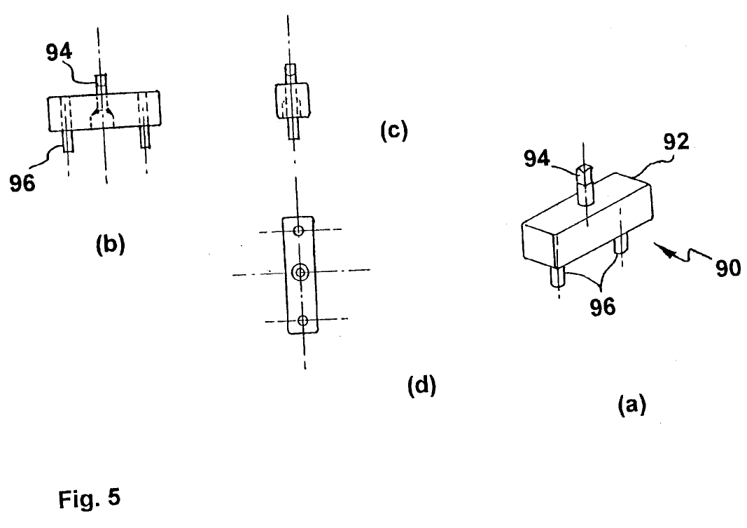

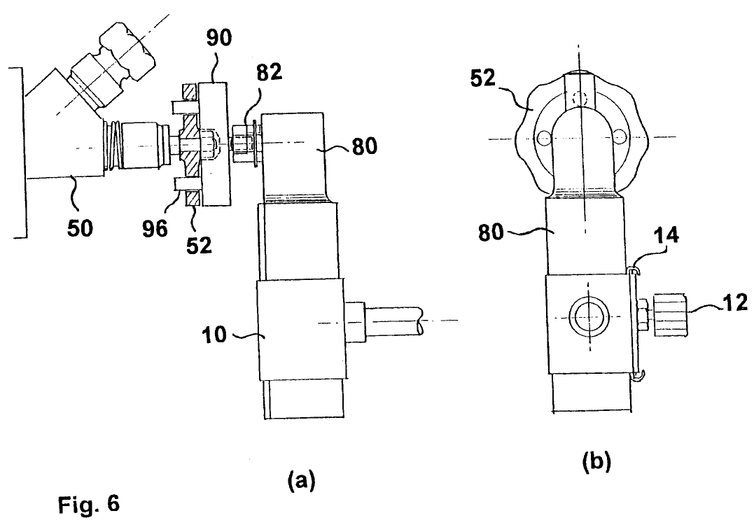

The ratchet output in the form of an impulse coupler hexagonal socket may be directly coupled to the valve stem. Alternatively, a valve spindle adapter may form an interface between the impulse coupler and a hand wheel on the exit valve. The use of such an adapter is shown by way of example in FIGS. 4 and 6. The adapter will now be described with reference to FIGS. 5 and 6.

Referring to FIG. 5, the valve spindle adapter 90 consists of a square bar 92, suitably of mild steel. One major face of the bar 92 carries a stainless steel stem 94. The opposite major face of the bar 92 carries two steel pegs or prongs 96 that are spaced apart from one another. FIG. 6 is a close-up view of the adapter 90 in use. The stem 94 is received in the impulse coupler 82 and tightened using a set screw. The two pegs 96 on the other side of the adapter are inserted into the apertures between the spokes and perimeter of the hand wheel 52 of the valve 50.

The above-described mounting assembly and valve spindle adapter permit application to any horizontally laid ton container irrespective of the drum design and diameter, and also for the ratchet to be fitted directly onto any type of chlorine valve commonly used, such as Y valves, without the need to remove the valve hand wheel. The process of installing and securing the safety device system is much simplified and more user-friendly as compared with the bracket described in the introduction that is fitted manually to the inner chime of containers of US standard. Similarly, temporary removal of the actuator from the valve may be quickly and easily done for the purposes of maintenance and replacement work.

The invention may be embodied in numerous other ways without departing from the scope of the invention as defined in the claims.

What is claimed is:

1. A mounting assembly for positioning a valve actuator in operational engagement with an exit valve located on a fluid storage container, the assembly comprising a valve actuator holder, means for controllably moving the holder so as to position a said valve actuator held by the holder in operational engagement with the valve, and support means for securing the assembly to a support surface other than the container or valve.

2. A mounting assembly according to claim 1, wherein said means for controllably moving said valve actuator holder comprises an arm that carries said valve actuator holder, said arm arranged for moving said valve actuator holder independently in different directions.

3. A mounting assembly according to claim 2, wherein said arm is extendible axially and is adjustable in its height relative to said support surface.

4. A mounting assembly according to claim 3, wherein said means for controllably moving said valve actuator holder further comprises a bracket that couples said arm to said support means.

5. A mounting assembly according to claim 4, wherein said bracket is controllably movable and securable relative to said support means to perform said height adjustment.

6. A mounting assembly according to claim 4, wherein said arm is pivotally coupled to said bracket whereby said valve actuator holder can be swung vertically into proximity of said valve or out of proximity therefrom.

7. A mounting assembly according to claim 6, wherein the bracket and arm interact to limit the lower extent of swing of said arm to a horizontal disposition.

8. A mounting assembly according to claim 6, wherein the bracket and arm interact to limit the upper extent of swing of said arm to a rearward disposition at an acute angle with said bracket.

9. A mounting assembly according to claim 4, wherein said bracket is pivotally connected to said support means to swing said arm horizontally.

10. A mounting assembly according to claim 1, wherein said support means includes a base plate, said base plate adapted for securing to said support surface.

11. A mounting assembly according to claim 1, wherein said valve actuator is a pneumatic ratchet.

12. A safety system for automatically shutting an exit valve of a fluid storage container, the system including a pneumatic ratchet in operational engagement with the valve, and a mounting assembly according to any one of the preceding claims that supports the ratchet, wherein the mounting assembly is secured exclusively to a support surface other than the container or valve.
